(19) United States
(12) Patent Application Publication
(10) Pub. No.: US 2021/0061138 A1
(43) Pub. Date: Mar. 4, 2021

(54) OSCILLATING VEHICLE SEAT FOR OCCUPANT COMFORT

(71) Applicant: Lear Corporation, Southfield, MI (US)

(72) Inventors: Ashwini MAHINDRAKAR, Southfield, MI (US); Arjun YETUKURI, Rochester Hills, MI (US); Mladen HUMER, West Bloomfield, MI (US)

(21) Appl. No.: 16/560,077

(22) Filed: Sep. 4, 2019

(51) Int. Cl. B60N 2/10; B60N 2/02; B60N 2/26; B60W 40/08

(52) U.S. Cl. CPC B60N 2/10; B60N 2/0244; B60N 2002/0204; B60W 40/08; B60N 2/26

(57) ABSTRACT

A vehicle seat assembly is provided with a seat bottom and seatback. An actuator is in cooperation with the seat bottom and the seatback. A controller is in electrical communication with the actuator. The controller is programmed to receive input indicative of selection of an automatic mode. In response to the automatic mode selection, the controller determines if a seated occupant is in an agitated condition. In response to the automatic mode selection and the agitated condition, a signal is output to the actuator to oscillate the seatback and the seat bottom. Input indicative of selection of a manual mode is received. Input indicative that a seated occupant is in the agitated condition is received. In response to the manual mode selection, and the agitated condition, a signal is output to the actuator to oscillate the seatback and the seat bottom.

### TECHNICAL FIELD

Various embodiments relate to adjustable seat assemblies.

### BACKGROUND

Driver distraction is a major factor in increasing fatalities on our roads. According to new eye-tracking research, drivers take their eyes off the road for over two miles in a one-hour journey whilst driving in urban traffic, which is about seven percent of the time.

### SUMMARY

According to at least one embodiment, a vehicle seat assembly is provided with a seat bottom adapted to be mounted to a vehicle floor. A seatback is adapted to be pivotally mounted adjacent to the seat bottom. An actuator is in cooperation with the seat bottom or the seatback. A controller is in electrical communication with the actuator and programmed to determine if a seated occupant is in an agitated condition. In response to determining the agitated condition, a signal is output to the actuator to oscillate the seatback, or to oscillate the seat bottom.

According to a further embodiment, the seat bottom is adapted to receive and support a booster seat thereon.

According to another further embodiment, the seat bottom and the seatback are adapted to receive and support a forward-facing child seat thereon.

According to another further embodiment, the seat bottom and the seatback are adapted to receive and support a rearward-facing child seat thereon.

According to another further embodiment, the actuator is in cooperation with the seat bottom and the seatback to oscillate the seat bottom and the seat back.

According to another further embodiment, the seat bottom is adapted to be mounted to the vehicle floor and pivotal about an axis that is generally perpendicular to a fore-aft direction of the vehicle seat assembly. The actuator pivots the seat bottom about the pivotal axis.

According to another further embodiment, the controller is in electrical communication with a vehicle controller and the vehicle seat assembly controller is further programmed to receive input indicative of an active vehicle status. In response to receiving the input indicative of the active vehicle status and in response to determining the agitated condition, a signal is output to the actuator to oscillate the seatback, or to oscillate the seat bottom.

According to another further embodiment, the controller is further programmed to receive input indicative of a distracted driver. In response to receiving the input indicative of the distracted driver and in response to determining the agitated condition, a signal is to the actuator to oscillate the seatback, or the oscillate the seat bottom.

According to another further embodiment, the controller is further programmed to determine if the seated occupant is in a calmed condition. A signal is output to the actuator to discontinue oscillating the seatback or the seat bottom in response to determining the calmed condition.

According to another further embodiment, the controller is further programmed to determine if the seated occupant is in the agitated condition after a predetermined period of oscillation at a first rate of oscillation. In response to determining the agitated condition after the predetermined period of oscillation, a signal is output to the actuator to oscillate the seatback, or to oscillate the seat bottom at a second rate of oscillation that is different than the first rate of oscillation.

According to another further embodiment, the controller is in electrical communication with a microphone. The controller is further programmed to receive audio data from the seated occupant. The controller determines if the seated occupant is crying, fussing, or calling from the audio data. If the seated occupant for example, is crying, fussing, or calling, it is determined that the seated occupant is in the agitated condition.

According to another further embodiment, the controller is in electrical communication with a microphone. The controller is further programmed to receive audio data from the seated occupant. The controller determines if the seated occupant is in a playful condition from the audio data.

According to an even further embodiment, the controller is further programmed to determine that the playful condition is the agitated condition.

According to another further embodiment, the controller is in electrical communication with a camera. The controller is further programmed to receive video data from the seated occupant. The controller determines if the seated occupant is in the agitated condition from the video data.

According to an even further embodiment, the controller is in electrical communication with a display. The controller is programmed to display the video data from the seated occupant on the display. Input indicative of a manual termination of the oscillation is received by the controller. A signal is transmitted to discontinue the oscillation in response to the input indicative of the manual termination of the oscillation.

According to another further embodiment, the controller is further programmed to output the signal to the actuator to oscillate the seatback, or to oscillate the seat bottom with a higher acceleration toward a seating surface than an acceleration away from the seating surface.

According to another embodiment, a method for calming or resting a seated occupant provides a vehicle seat assembly with an actuator. An occupant is seated in the vehicle seat assembly. The vehicle seat assembly is oscillated.

According to a further embodiment, the method determines that the seated occupant is in an agitated condition or an awake condition. The seat assembly is oscillated in response to the agitated condition or the awake condition. The method determines that the seated occupant is in a calmed condition or a rest condition. Oscillation of the vehicle seat assembly is discontinued in response to the calmed condition or the rest condition.

According to another further embodiment, the method determines that the seated occupant is in the agitated condition or the awake condition after a predetermined period of oscillation at a first rate of oscillation. In response to the agitated condition or the awake condition after the predetermined period of oscillation, the vehicle seat assembly is oscillated at a second rate of oscillation that is different than the first rate of oscillation.

According to another further embodiment, the method monitors a status of the seated occupant. An active status of the vehicle or a status of a driver is monitored. The driver is alerted of the seated occupant status in response to a change in the active status of the vehicle or the driver egressing the vehicle.

According to another further embodiment, after a predetermined period of oscillation of the seat assembly, a determination is made if the seated occupant is calm or resting. Oscillation is discontinued in response to the calm or rested status of the seated occupant.

According to an even further embodiment, a rate of oscillation is stored in response to the determination that the seated occupant is calm or resting.

According to another even further embodiment, oscillation is initiated of the vehicle seat assembly at the stored rate of oscillation.

According to another further embodiment, after a predetermined period of oscillation of the seat assembly, a determination is made if the seated occupant is calm or resting. Oscillation is continued if the seated occupant is not calm or not rested.

According to another further embodiment, after a predetermined period of oscillation of the seat assembly, a determination is made if the seated occupant is calm or resting. Oscillation is discontinued if the seated occupant is less calm or less rested than a prior status.

According to another embodiment, a vehicle seat assembly is provided with a seat bottom adapted to be mounted to a vehicle floor. A seatback is adapted to be pivotally mounted adjacent to the seat bottom. An actuator is in cooperation with the seat bottom and the seatback. A controller is in electrical communication with the actuator. Input indicative of selection of a manual mode is received. Input indicative that the seated occupant is in the agitated condition is received. In response to the manual mode selection, and the agitated condition, a signal is output to the actuator to oscillate the seatback and/or the seat bottom.

According to a further embodiment, the controller is further programmed to receive input indicative of selection of an automatic mode. In response to the automatic mode selection, the controller determines if a seated occupant is in an agitated condition. In response to the automatic mode selection and the agitated condition, a signal is output to the actuator to oscillate the seatback and/or the seat bottom.

According to an even further embodiment, the actuator is further provided with at least one air bladder. The signal to oscillate the seatback or the seat bottom inflates and deflates the air bladder to adjust a seating surface of the seat bottom or the seatback.

According to another embodiment, a method for monitoring a seated occupant monitors a status of a seated occupant. An active status of the vehicle or a status of a driver is monitored. A driver is alerted of the seated occupant status in response to a change in the status of the vehicle or the driver egressing the vehicle.

### BRIEF DESCRIPTION OF THE DRAWINGS

FIG. 1 illustrates a seating system according to an embodiment, depicted in various seating arrangements and operational in an automatic mode; and

FIG. 2 illustrates the seating system of FIG. 1 according to another embodiment, depicted in a manual mode.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

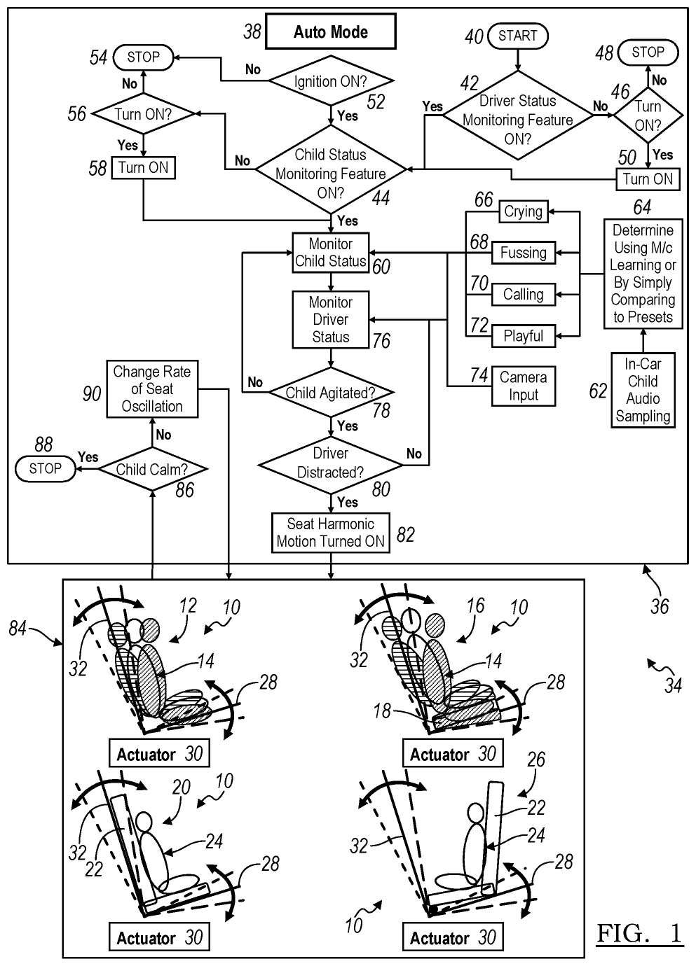

FIG. 1 schematically illustrates a seat assembly 10 according to an embodiment. The seat assembly 10 is depicted schematically and illustrated in various seating arrangements. The seat assembly 10 may be a vehicle seat assembly for a land vehicle, watercraft, aircraft, or the like. For the depicted embodiment, the seat assembly 10 is a rear row seat assembly 10. However, any seating arrangement may employ the seat assembly 10.

The seat assembly 10 employs a harmonic seat tilt for occupant comfort and for mitigating driver distraction. Occupant comfort enhances the transportation experience of the occupant. When the occupant is a child, child comfort calms a child. An uncomfortable child may become uncalm or agitated, which may distract the driver. The seat assembly 10 and associated system identifies that the driver is distracted, alerts the driver, and mitigates the distraction. The distraction may be mitigated indirectly. For example, providing occupant comfort to a child passenger may calm the child and reduce driver distractions caused by the child. The seat assembly 10 and associated system facilitate a comfortable transition of a child occupant or multiple child occupants to a calmed state, for example, sleep. Alternatively, the seat assembly 10 may be any seat assembly, even including a driver seat assembly.

The seat assembly 10 is illustrated in a first child seating position 12, which may be an ordinary design position 12, whereby a larger child 14 sits upon the seat assembly 10 in an ordinary forward-facing design position. The seat assembly 10 is also illustrated in a booster seating position 16, whereby a booster seat 18 is provided upon the seat assembly 10 for supporting the larger child 14. The seat assembly 10 provides a forward-facing child seat position 20 to support a child seat 22 to seat a forward-facing smaller child 24. The seat assembly 10 also provides a rearward-facing child seat position 26 to support the child seat 22 to seat the smaller child 24 to face rearward.

The seat assembly 10 includes a seat bottom 28 adapted to be mounted to a vehicle body or a vehicle floor. The seat bottom 28 may include a seat cushion, a cushion length extender (CLE), both, or any lower structural occupant support. The seat bottom 28 is connected to an actuator 30, which may be a motor-driven tilt actuator 30 for adjusting an angle of the seat bottom 28 about an axis that is perpendicular to a travel direction of the vehicle, and/or a fore/aft direction of the vehicle seat. A seat bottom 28 actuated by the actuator 30 can pivot in a range as illustrated. Tilt actuators 30 for seat bottoms 28 are known in the art. Alternatively, the actuator 30 may be an air bladder assembly within the seat bottom 28 for inflating and deflating to adjust the tilt angle of a seating surface of the seat bottom 28. Alternatively, the actuator 30 may be a CLE, which is used to pivot a child restraint system (CRS) upon the seat bottom 28. The CLE may extend in a fore and aft direction. Alternatively, or additionally, the CLE may provide vertical or upright adjustment in an up and down direction.

The seat assembly 10 includes a seatback 32 pivotally mounted adjacent to the seat bottom 28. The seatback 32 may be pivotally mounted directly to the seat bottom 28 as is known in the art. The seatback 32 is illustrated with a pivotal range of motion. The seatback 32 may be tilted by the tilt actuator 30 according to an embodiment. According to another embodiment, the actuator 30 includes the tilt actuator 30 and a recline actuator 30 to adjust a recline angle of the seatback 32 relative to the vehicle floor. According to another embodiment, the seatback 32 is mounted to the vehicle body and is pivoted by a recline actuator 30. According to another embodiment, the seatback 32 is not pivotal relative the seat bottom 28, but is actuated by the actuator 30 to pivot with the seat bottom 28. According to yet another embodiment, the actuator 30 includes an air bladder assembly 30 for inflating and deflating to adjust a recline angle of a contact surface of the seatback 32.

Rocking of the seat assembly 10 can cause the child 14, 24 to become calm, and/or fall asleep to mitigate or avoid being a distraction to an associated driver. Repeated use of the front cushion or seat bottom 28 tilt and seatback 32 recline functions of the actuators 30, in synchronized oscillation can generate a rocking motion of the child 14, 24. The oscillations of the seat bottom 28 and the seatback 32 can be gradual and repetitive to provide the rocking motion. Alternatively, the air bladders assemblies 30 can be inflated and deflated alternatively between the seat cushion 28 and the seatback 32 asynchronously to provide the rocking motion.

FIG. 1 also illustrates a seating system 34 for a vehicle. The seating system 34 includes a controller 36 in electrical communication with the actuators 30. The controller 36 may be a module within a vehicle controller. Alternatively, the controller 36 may be disposed within or under the vehicle seat assembly 10. The methodology of the controller 36 may be stored on a physical module or may be stored on any computer-program product that may be embodied in a non-transitory readable medium that is programmed to automatically adjust the seat assembly 10.

The controller 36 is depicted after selection of an automatic mode 38 according to an embodiment. The controller 36 is also depicted with an example of a method for the automatic mode 38 in a flowchart form. The automatic mode begins at start 40. At decision block 42, the controller 36 determines if a driver status monitoring feature is initialized. If yes, then the method continues to decision block 44. If no, then the method proceeds to decision block 46 to determine if the driver monitoring status is to be turned on. If no, then the method stops at block 48. If the driver monitoring status is turned on at decision block 46, then the monitoring status completes initiation at block 50 and proceeds to decision block 44.

Decision block 44 is preceded by an independent decision block 52 whereby the controller 36 communicates with a vehicle controller and determines if the vehicle is in an active status, such as when the car is started. According to one example, decision block 52 may determine if an ignition of the vehicle turned to on. If the vehicle does not have an active status, then the method stops at block 54. If the vehicle is started, then the method proceeds to decision block 44.

Decision block 44 determines if the child status monitoring feature is initiated, such as by a manual mode selection or a vehicle detection of a presence of child in the seat assembly 10. If not, then the method proceeds to another decision block 56 to determine if the child status monitoring feature is to be turned on. If the child status monitoring feature is not yet initiated, then the method discontinues at block 54. If the child status monitoring feature is to be turned on at block 56, then the feature is initiated at block 58 and the method proceeds to block 60.

Referring again to decision block 44, if the child status monitoring feature is turned on, then the method proceeds to block 60. The vehicle includes in-car child audio sampling by a microphone and the data is input at block 62. At block 64 the controller 36 determines using machine learning methods known in the art or by simply comparing presets to the input whether the child 14, 24 is crying at input block 66, fussing at input block 68, calling at input block 70 and/or playful at input block 72. A camera input of the child 14, 24 and/or the driver may be provided at block 74.

Block 60 monitors the status of the child based on the audio inputs 66, 68, 70, 72 and the camera input 74. Block 76 monitors the status of the driver based upon the camera input 74 or other systems available in the vehicle or known in the art. At decision block 78 the controller 36 determines if the child is agitated. The determination is based on whether any of the audio and video inputs 66, 68, 70, 72, 74 meet a particular threshold, which may be predetermined or learned over time or set by driver (or caregiver). The playful input 72 may be utilized to determine that the child 14, 24 is agitated to distinguish from the other audio inputs 66, 68, 70. Alternatively, the playful input 72 may be utilized to determine that the child 14, 24 is not agitated. The interpretation of the playful input 72 as agitated or not may be dependent upon age of the child 14, 24 or on distraction preferences of a particular driver, such as whether a sleeping child 14, 24 is preferred over a playful child 14, 24.

If decision block 78 determines that the child 14, 24 is not agitated, then the method returns to block 60 to monitor inputs 66, 68, 70, 72, 74 from the child. If decision block 78 determines that the child is agitated, then the method proceeds to decision block 80 to determine if the driver is distracted. The driver distraction 80 is determined by analyzing the camera input 74, for example to determine if the driver has looked away from the road for a predetermined period of time. If the controller 36 determines that the driver is not distracted at decision block 80, then monitoring driver status is repeated at block 76 to evaluate refreshed input 74 about the driver. If the driver is determined to be distracted at block 80, then the seat harmonic motion is turned on at block 82; and the seat assembly 10 is oscillated at block 84.

The oscillatory motion of the seat assembly 10 may be consistent or may vary. For example, the cyclic pulsing of the oscillations may be biased. For example, the pulse may be stronger, by higher acceleration in a direction of pushing the seat into the child 14, 24. Likewise, the pulse may be weaker with a lower acceleration in a direction opposite of pushing the seat into the child 14, 24 to minimized moving the seat assembly 10 away from the child 14, 24. The asymmetrical pulse is reversible depending whether the child 14, 24 is in a forward-facing position 12, 16 20, or in a rearward-facing position 26, such that the asymmetry always urges the child 14, 24 to sink into the seat assembly 10. The driver can vary the pulse intensity according to an embodiment.

After a predetermined period of oscillation of the seat assembly 10, the controller 36 determines at block 86 whether the child 14, 24 is calm. If yes, then the method is complete at block 88 and the seat is returned to its original orientation. If not, the controller changes a rate of oscillation of the seat assembly at block 90, and then repeats the oscillation at block 84. This oscillation step 84 may be repeated until the child is calmed at block 86 and the method completes at step 88. According to another embodiment, as a result of the change of oscillation in step 90, the controller 36 may determine that the child is more agitated. If so, the controller 36 may turn off the harmonic feature and let the caregiver address the situation, by converting to a manual mode, or providing an option to the driver to decide to turn off the harmonic oscillation. According to another embodiment, the controller 36 may determine a rate of oscillation that succeeded in calming the child. If so, the calming rate of oscillation may be stored by the controller 36 and used subsequently as a starting or default oscillation rate.

According to another embodiment, the camera input 74 may also be presented to the driver on a screen. By visually monitoring the status of the child, the driver can decide to turn off the harmonic motion or not.

According to another embodiment, the controller 36 may monitor the status of the driver. If the driver egresses the vehicle while the child 14, 24 is present, the controller 36 may send a signal to a media device to alert the driver that the child 14, 24 is still present in the vehicle.

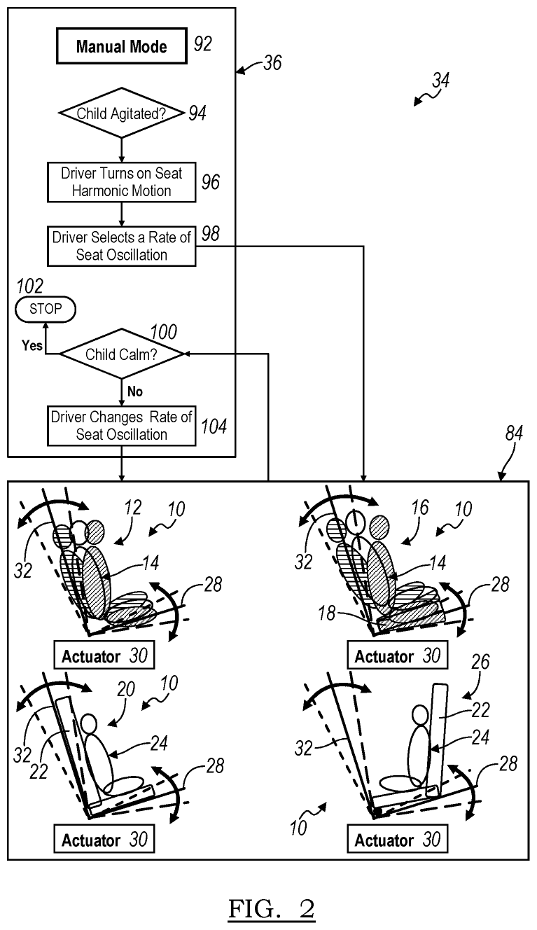

FIG. 2 illustrates the controller 36 upon selection of a manual mode 92. At decision block 94, a user, such as the driver or another occupant, determines whether the child 14, 24 is agitated. Alternatively, the controller 36 could determine whether the child 14, 24 is agitated by analyzing the inputs 66, 68, 70, 72, 74. At block 96, the user initiates the seat harmonic motion. At block 98, the user selects a rate of seat oscillation. Then, at block 84, the seat assembly 10 is oscillated as described above. After a predetermined period of time, the user or the controller 36 determine whether the child has calmed at block 100. If so, the method terminates at block 102. If not, then the user changes the rate of oscillation at block 104, and the oscillation repeats at block 84. The oscillation may be repeated sequentially until the child is calm at block 100 and the method is discontinued at block 102. Alternatively, the user may decide that oscillation is ineffective for calming the seated child and may discontinue the method.

Alternatively, the user may want to make the child 14, 24 sleep to rest the child even if the child 14, 24 is not agitated. Accordingly, the method of FIG. 2 may be employed, whereby the user or controller 36 determine that the child 14, 24 is awake, and employ the oscillation to rest the child 14, 24.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle seat assembly comprising:
a seat bottom adapted to be mounted to a vehicle floor;
a seatback adapted to be pivotally mounted adjacent to the seat bottom;
an actuator in cooperation with the seat bottom or the seatback; and
a controller in electrical communication with the actuator and programmed to:
determine if a seated occupant is in an agitated condition, and
in response to determining the agitated condition, output a signal to the actuator to oscillate the seatback, or to oscillate the seat bottom.

2. The vehicle seat assembly of claim 1 wherein the seat bottom is adapted to receive and support a booster seat thereon.

3. The vehicle seat assembly of claim 1 wherein the seat bottom and the seatback are adapted to receive and support a child seat thereon.

4. The vehicle seat assembly of claim 1 wherein the actuator is in cooperation with the seat bottom and the seatback to oscillate the seat bottom and the seat back.

5. The vehicle seat assembly of claim 1 wherein the seat bottom is adapted to be mounted to the vehicle floor and pivotal about an axis that is generally perpendicular to a fore-aft direction of the vehicle seat assembly; and
wherein the actuator pivots the seat bottom about the pivotal axis.

6. The vehicle seat assembly of claim 1 wherein the controller is in electrical communication with a vehicle controller and the vehicle seat assembly controller is further programmed to:
receive input indicative of an active vehicle status; and
in response to receiving the input indicative of the active vehicle status and in response to determining the agitated condition, output a signal to the actuator to oscillate the seatback, or to oscillate the seat bottom.

7. The vehicle seat assembly of claim 1 wherein the controller is further programmed to:
receive input indicative of a distracted driver; and
in response to receiving the input indicative of the distracted driver and in response to determining the agitated condition, output a signal to the actuator to oscillate the seatback, or the oscillate the seat bottom.

8. The vehicle seat assembly of claim 1 wherein the controller is further programmed to:
determine if the seated occupant is in a calmed condition; and
output a signal to the actuator to discontinue oscillating the seatback or the seat bottom in response to determining the calmed condition.

9. The vehicle seat assembly of claim 1 wherein the controller is further programmed to:
determine if the seated occupant is in the agitated condition after a predetermined period of oscillation at a first rate of oscillation; and
in response to determining the agitated condition after the predetermined period of oscillation, output a signal to the actuator to oscillate the seatback, or to oscillate the seat bottom at a second rate of oscillation that is different than the first rate of oscillation.

10. The vehicle seat assembly of claim 1 wherein the controller is in electrical communication with a microphone, and further programmed to:
receive audio data from the seated occupant;
determine if the seated occupant is crying, fussing, calling, or playful from the audio data; and
if the seated occupant is crying, fussing, calling, or playful determine that the seated occupant is in the agitated condition.

11. The vehicle seat assembly of claim 1 wherein the controller is in electrical communication with a camera, and further programmed to:
receive video data from the seated occupant; and
determine if the seated occupant is in the agitated condition from the video data.

12. The vehicle seat assembly of claim 11 wherein the controller is in electrical communication with a display, and further programmed to:
displaying the video data from the seated occupant on the display;
receiving input indicative of a manual termination of the oscillation; and
transmitting a signal to discontinue the oscillation in response to the input indicative of the manual termination of the oscillation.

13. The vehicle seat assembly of claim 1 wherein the controller is further programmed to output the signal to the actuator to oscillate the seatback, or to oscillate the seat bottom with a higher acceleration toward a seating surface than an acceleration away from the seating surface.

14. A method for calming or resting a seated occupant, the method comprising:
providing a vehicle seat assembly with an actuator;
seating an occupant in the vehicle seat assembly; and
oscillating the vehicle seat assembly.

15. The method of claim 14 further comprising:
determining that the seated occupant is in an agitated condition or an awake condition, wherein the vehicle seat assembly is oscillated in response to the agitated condition or the awake condition;
determining that the seated occupant is in a calmed condition or a rest condition; and
discontinuing oscillation of the vehicle seat assembly in response to the calmed condition or the rest condition.

16. The method of claim 14 further comprising:
determining that the seated occupant is in the agitated condition or the awake condition after a predetermined period of oscillation at a first rate of oscillation; and
in response to the agitated condition determination or the awake condition determination after the predetermined period of oscillation, oscillating the vehicle seat assembly at a second rate of oscillation that is different than the first rate of oscillation.

17. The method of claim 14 further comprising storing a rate of oscillation in response to determining that the seated occupant is calm or resting.

18. The method of claim 14 further comprising:
after a predetermined period of oscillation of the seat assembly, determining if the seated occupant is calm or resting; and
continuing oscillation if the seated occupant is not calm or not rested.

19. The method of claim 14 further comprising:
after a predetermined period of oscillation of the seat assembly, determining if the seated occupant is calm or resting; and
discontinuing oscillation if the seated occupant is less calm or less rested than a prior status.

20. A vehicle seat assembly comprising:
a seat bottom adapted to be mounted to a vehicle floor;
a seatback adapted to be pivotally mounted adjacent to the seat bottom;
an actuator in cooperation with the seat bottom and the seatback; and
a controller in electrical communication with the actuator and programmed to:
receive input indicative of selection of a manual mode,
receive input indicative that the seated occupant is in the agitated condition, and
in response to the manual mode selection, and the agitated condition, output a signal to the actuator to oscillate the seatback or the seat bottom.
